(19) United States
(12) Patent Application Publication
(10) Pub. No.: US 2024/0125665 A1
(43) Pub. Date: Apr. 18, 2024

(54) NEAR-FIELD COMMUNICATION-BASED TIRE PRESSURE MONITORING SYSTEM, SENSOR, TIRE, AND VEHICLE

(71) Applicant: HAMATON AUTOMOTIVE TECHNOLOGY CO., LTD, Hangzhou, Zhejiang (CN)

(72) Inventors: Jianer ZHANG, Hangzhou, Zhejiang (CN); Mingguang YU, Hangzhou, Zhejiang (CN); Peter MACKEL, Hangzhou, Zhejiang (CN); Haijun DING, Hangzhou, Zhejiang (CN); Zenan HU, Hangzhou, Zhejiang (CN)

(21) Appl. No.: 17/754,916

(22) PCT Filed: Mar. 12, 2020
(86) PCT No.: PCT/CN2020/078918

§ 371 Date: Apr. 15, 2022

(30) Foreign Application Priority Data
Oct. 17, 2019 (CN) 201910990350.X

(51) Int. Cl. G01L 17/00; B60C 23/02

(52) U.S. Cl. CPC G01L 17/00; B60C 23/02; H04B 5/70

(57) ABSTRACT

A near-field communication-based tire pressure monitoring system, a sensor, a tire, and a vehicle. The tire pressure monitoring system comprises a server (101), a terminal (102) supporting near-field communication, and a tire pressure monitoring sensor (103) supporting near-field communication. The terminal (102) obtains from the server (101) update information for updating the tire pressure monitoring sensor (103), and then the update information is transmitted to the tire pressure monitoring sensor (103) by establishing a near-field communication connection between the terminal (102) and the server (101), so that the tire pressure monitoring sensor (103) realizes information reconfiguration or programming process. The terminal (102) is connected to the tire pressure monitoring sensor (103) by means of near-field communication, and compared with wireless communication, the near-field communication avoids the interference of irrelevant signals, guaranteeing the normal communication process. Since the interference of irrelevant signals is avoided, hang-up prevention is encrypted in the near-field communication process without additionally increasing a processing packet, and the cost is reduced.

### CROSS-REFERENCE TO RELATED APPLICATION

The present application claims priority to Chinese Application No. 201910990350.X, filed on Oct. 17, 2019, entitled “Near-Field Communication-Based Tire Pressure Monitoring System, Sensor, Tire, and Vehicle”, which is hereby incorporated by reference in its entirety.

### TECHNICAL FIELD

The present disclosure relates to the technical field of vehicle safety, in particular to a near-field communication-based tire pressure monitoring system, a sensor, a tire and a vehicle.

### BACKGROUND

Tire Pressure Monitoring System (TPMS) refers to an auxiliary system installed on automobile tires for real-time monitoring of tire pressure. By installing a transmitter containing a high-sensitivity sensor chip on each tire, the pressure, temperature and other data of the tire are monitored in real time under driving or stationary conditions, and transmitted to the controller by radio frequency. When the tire leaks or has low pressure, an alarm is made to ensure the driving safety.

Most of the current TPMS sensors are originally installed in the original factory. After improving the TPMS sensors, it is necessary to replace the previous TPMS sensors on the tires with new TPMS sensors, which requires the tire service store to stock a plurality types of original sensors, resulting in inconvenient operation and high cost of replacing the TPMS sensors. Of course, there are also methods that can update the TPMS sensors through wireless communication, but special handheld tools are needed to update the TPMS sensors. The handheld tools are expensive, thus causing an additional economic burden. On the other hand, the wireless communication process is susceptible to interference, which cannot guarantee a smooth TPMS sensors update process.

In a practical application, the inventors found that the update of the existing tire pressure monitoring sensor is interfered by the wireless communication process, and the update process is prone to error interruption.

### SUMMARY

The embodiments of the present disclosure provide a near-field communication-based tire pressure monitoring system, a sensor, a tire and a vehicle to solve the problem that updating the tire pressure monitoring sensor in the related art is interfered by the wireless communication process and the updating process is prone to error interruption.

In view of the above technical problems, according to a first aspect, an embodiment of the present disclosure provides a near-field communication-based tire pressure monitoring system, including a server, a terminal supporting near-field communication and a tire pressure monitoring sensor supporting the near-field communication; where
the terminal is configured to, after receiving a first request information for updating the tire pressure monitoring sensor, obtain vehicle information of a vehicle where the tire pressure monitoring sensor is located and send the vehicle information to the server;
the server is configured to, after receiving the vehicle information, query updating information corresponding to the vehicle information and send the updating information to the terminal; and
the terminal is further configured to receive the updating information, and after detecting a connection establishing the near-field communication with the tire pressure monitoring sensor, send the updating information to the tire pressure monitoring sensor;
where, the updating information includes configuration information for configuring the tire pressure monitoring sensor or programming information for programming the tire pressure monitoring sensor; and the vehicle information includes vehicle brand and vehicle model.

In an embodiment,
the terminal is further configured to, after detecting the connection establishing the near-field communication with the tire pressure monitoring sensor, and when receiving a second request information of tire pressure monitoring data for monitoring a tire, send the second request information to the tire pressure monitoring sensor; and
the tire pressure monitoring sensor is configured to, after receiving the second request information, send the stored tire pressure monitoring data to the terminal through the connection establishing the near-field communication, for the terminal to display received tire pressure monitoring data.

In an embodiment,
the terminal is further configured to send the received tire pressure monitoring data to the server, for the server to store the received tire pressure monitoring data.

In an embodiment, the terminal is a smart phone or a handheld tablet.

In an embodiment,
the terminal is further configured to, after receiving a third request information uploading the updating information of the vehicle to the server, obtain the updating information and the vehicle information corresponding to the updating information, and send the updating information and the vehicle information corresponding to the updating information to the server; and
the server is further configured to store the received updating information and vehicle information corresponding to the updating information.

According to a second aspect, the present disclosure provides a tire pressure monitoring sensor, including a processor and an antenna for near-field communication;
after the tire pressure monitoring sensor establish a connection of the near-field communication with a terminal, the antenna receives updating information sent by the terminal, and the processor processes the updating information;
where, the updating information including configuration information for configuring the tire pressure monitoring sensor or programming information for programming the tire pressure monitoring sensor.

In an embodiment, the antenna is fixed on a sealing upper cover or a sealing lower cover of the tire pressure monitoring sensor;
the antenna and a main printed circuit board in the processor are conducted by a metal wire through welding, or the antenna and the main printed circuit board in the processor are conducted by a metal contact pin.

According to a third aspect, the present disclosure provides a tire, including the tire pressure monitoring sensor described above; where
the tire pressure monitoring sensor is locked on a valve mouth of the tire or attached to a rubber inner surface of the tire.

According to a fourth aspect, the present disclosure provides a vehicle, including the tire described above.

The embodiments of the present disclosure provide a near-field communication-based tire pressure monitoring system, a sensor, a tire and a vehicle. The tire pressure monitoring system includes a server, a terminal supporting near-field communication and a tire pressure monitoring sensor supporting the near-field communication. After the terminal obtains updating information for updating the tire pressure monitoring sensor from the server, the updating information is transmitted to the tire pressure monitoring sensor by establishing a connection of the near-field communication with the terminal and the server, so that the tire pressure monitoring sensor may realize information reconfiguration or programming process. The connection between the terminal and the tire pressure monitoring sensor is established through the near-field communication. Compared with wireless communication, the near-field communication avoids the interference of irrelevant signals and ensures the normal communication process. Since the interference of irrelevant signals is avoided, additional processing messages are not needed to encrypt and prevent errors in the near-field communication process, which reduces the cost.

### BRIEF DESCRIPTION OF DRAWINGS

The drawings needed in the description of the embodiments or the related art are briefly introduced below so that technical solutions of the embodiments of the present disclosure or related art may be more clearly illustrated. Obviously, the drawings in the following description are only some embodiments of the present disclosure. For those of ordinary skill in the art, other drawings may also be obtained according to these drawings without paying creative labor.

FIG. 1 is a structural diagram of a near-field communication-based tire pressure monitoring system in accordance with an embodiment of the present disclosure; and

FIG. 2 is a circuit block diagram of a tire pressure monitoring sensor in accordance with another embodiment of the present disclosure.

### DETAILED DESCRIPTION OF EMBODIMENTS

In order to make the objectives, technical solutions and advantages of the embodiments of the present disclosure clearer, the technical solutions of the embodiments of the present disclosure is clearly and completely described in combination with the drawings of the embodiments of the present disclosure. Obviously, the embodiments described are parts of the embodiments of the present disclosure, rather than all the embodiments. Based on the embodiments of the present disclosure, all other embodiments obtained by those of ordinary skill in the art without creative labor fall within the scopes of the protection of the present disclosure.

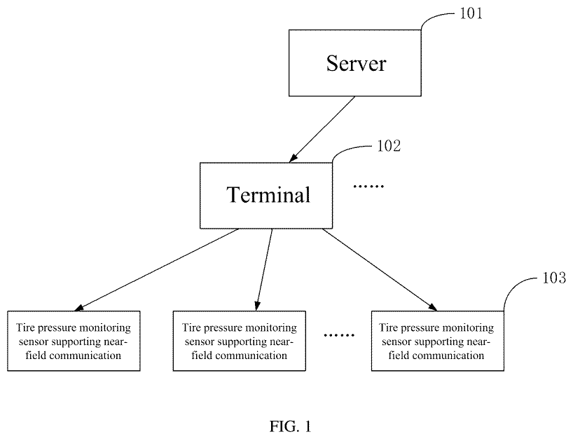

FIG. 1 is a structural diagram of a near-field communication-based tire pressure monitoring system in accordance with an embodiment of the present disclosure. Referring to FIG. 1, the near-field communication-based tire pressure monitoring system includes a sever 101, a terminal 102 supporting near-field communication, and a tire pressure monitoring sensor 103 supporting near-field communication; where
after receiving a first request information for updating the tire pressure monitoring sensor 103, the terminal 102 obtains vehicle information of a vehicle where the tire pressure monitoring sensor 103 is located and sends the vehicle information to the server 101;
after receiving the vehicle information, the server 101 queries updating information corresponding to the vehicle information and sends the update information to the terminal 102; and
the terminal 102 receives the updating information, and after detecting a connection establishing near-field communication with the tire pressure monitoring sensor 103, the updating information is sent to the tire pressure monitoring sensor 103;
where, the updating information includes configuration information for configuring the pressure monitoring sensor 103 or programming information for programming the tire pressure monitoring sensor 103; and the vehicle information includes vehicle brand, vehicle model, vehicle manufactory year and version number of program in the vehicle.

For a tire pressure monitoring sensor (TPMS sensor) that is configurable or programmable, the updating information of the tire pressure monitoring sensor may be sent to the tire pressure monitoring sensor using wireless communication technology, for example, using low frequency (LF) and radio frequency (RF) wireless communication technology to update the tire pressure monitoring sensor. However, such wireless communication technology is easily interfered when transmitting information. In order to avoid the interference in the process of information transmission and ensure a smooth updating process of tire pressure monitoring sensor, this embodiment provides the tire pressure monitoring system as shown in FIG. 1.

It should be noted that in the method of this embodiment, the terminal is usually a portable device such as a mobile phone or a handheld tablet. The terminal is equipped with an application (APP) that configures or programs the tire pressure monitoring sensor. When it is necessary to configure or program the tire pressure monitoring sensor in a tire of a vehicle, a user opens the APP on the terminal, inputs the vehicle information of the vehicle where the tire pressure monitoring sensor is located through the APP or selects the vehicle information through the APP, and clicks the functional button to obtain the updating information, that is, a request for obtaining updating information matching the vehicle information is sent to the server. The server transmits the updating information queried according to the vehicle information to the terminal. After the terminal receives the updating information, the user only needs to make the terminal close to the tire of the vehicle, so that the near-field communication (NFC) between the terminal and the tire pressure monitoring sensor can be established, the updating information may be transmitted to the tire pressure monitoring sensor. Then the tire pressure monitoring sensor may be configured or programmed according to the updating information received from the terminal.

In the tire pressure monitoring system shown in FIG. 1, both the terminal and the tire pressure monitoring sensor support the near-field communication (NFC), which avoids the interference in the process of updating information transmission. Furthermore, the terminal supporting the near-field communication may be a smart phone or handheld tablet without relying on dedicated handheld tools, which reduces the extra burden of purchasing handheld tools and reduces the cost of updating the tire pressure monitoring sensor. As the background of tire management and monitoring, the server not only stores the updating information of updating the tire pressure monitoring sensor, but also stores the monitoring results of the tire by the tire pressure monitoring sensor. The server and terminal may transmit information remotely through the network, for example, 4G network. Configuration information includes the corresponding protocols and parameters of each vehicle model under each vehicle brand. The first request information is triggered by the user on the terminal through a functional key that indicates an update to the tire pressure monitoring sensor.

As an illustration, an APP is installed in a mobile phone with NFC function, corresponding vehicle information is selected on the APP, and NFC data transmission is employed to achieve the purpose of TPMS sensor configuration or programming. In the near-field communication-based tire pressure monitoring system provided by this embodiment, hardware and software technologies of NFC are embedded into a general TPMS sensor, while it is ensured that other performance indexes of the TPMS sensor after embedding NFC are compatible with those of an original TPMS sensor. In addition, the NFC antenna may be introduced into the tire pressure monitoring sensor provided by this embodiment, while the introduction of the antenna may not interfere with the normal operation of the original LF and RF antenna of the tire pressure monitoring sensor.

This embodiment provides a near-field communication-based tire pressure monitoring system, including a server, a terminal supporting near-field communication and a tire pressure monitoring sensor supporting near-field communication. After the terminal obtains the updating information from the server to update the tire pressure monitoring sensor, the updating information is transmitted to the tire pressure monitoring sensor by establishing a connection establishing the near-field communication between the terminal and the server, so that the tire pressure monitoring sensor may realize information reconfiguration or programming process. The connection between the terminal and the tire pressure monitoring sensor is established through the near-field communication. Compared with wireless communication, the near-field communication avoids the interference of irrelevant signals and ensures the normal communication process. Since the interference of irrelevant signals is avoided, additional processing messages are not needed to encrypt and prevent errors in the near-field communication process, which reduces the cost.

Further, based on the embodiments above, the tire pressure monitoring system further includes:
after detecting the connection establishing the near-field communication with the tire pressure monitoring sensor, and when receiving a second request information for obtaining tire pressure monitoring data for monitoring a tire, the terminal transmits the second request information to the tire pressure monitoring sensor; and
after receiving the second request information, the tire pressure monitoring sensor sends the stored tire pressure monitoring data to the terminal through the connection establishing near-field communication, and the terminal displays the received tire pressure monitoring data.

Further, based on the embodiments above, the tire pressure monitoring system further includes:
the terminal sends the received tire pressure monitoring data to the server, and the server stores the received tire pressure monitoring data.

The tire pressure monitoring sensor may also send the tire pressure monitoring data monitoring the tire to the terminal through NFC. Similarly, the transmission of the tire pressure monitoring data through NFC avoids interference in the data transmission process. The second request information is triggered by the user on the terminal through a functional key that indicates obtaining the tire pressure monitoring data monitoring the tire. The terminal displays the tire pressure monitoring data after receiving the tire pressure monitoring data, and uploads the tire pressure monitoring data to the server to store the tire pressure monitoring data in the server.

This embodiment provides a near-field communication-based tire pressure monitoring system. The tire pressure monitoring sensor sends the tire pressure monitoring data to the terminal through near-field communication transmission, so that the operation of reading and uploading the tire pressure monitoring data to the background is realized without interference of signal transmission.

Further, based on the embodiments above, the terminal is a smart phone or a handheld tablet;
where, after receiving the vehicle information selected by the user through the application installed on the terminal, the terminal sends the vehicle information to the server to obtain the updating information corresponding to the vehicle information from the server. After the terminal establishes the connection of the near-field communication with the tire pressure monitoring sensor, the obtained updating information is sent to the tire pressure monitoring sensor.

When the tire pressure monitoring sensor needs to be configured or programmed, the application installed on the terminal is opened to obtain the updating information, and then the terminal is placed close to the tire. After the NFC is established with the tire pressure monitoring sensor, the updating information may be transmitted to the tire pressure monitoring sensor, so that the configuration and programming process of the tire pressure monitoring sensor may be completed.

This embodiment provides a near-field communication-based tire pressure monitoring system. A smart phone or a handheld tablet is used as the terminal in the tire pressure monitoring system. Through the APP installed on the mobile phone or handheld tablet, the tire pressure monitoring sensor is updated or the tire pressure monitoring data is transmitted, which does not require users to buy special handheld devices and saves costs.

Further, based on the embodiments above, the tire pressure monitoring system further includes:
after receiving a third request information uploading the updating information of the vehicle to the server, the terminal obtains the updating information and the vehicle information corresponding to the updating information, and sends the updating information and the vehicle information corresponding to the updating information to the server; and
the server stores the received updating information and vehicle information corresponding to the updating information;
when receiving a fourth request information for adding new vehicle information and storing the new vehicle information, and after receiving new updating information corresponding to the new vehicle information, the server stores the new updating information and the new vehicle information corresponding to the new updating information.

The updating information of the tire pressure monitoring sensor may be uploaded to the server through the terminal, for example, the configuration information is input through the terminal and is uploaded to the server by the terminal; programming information (for example, upgrading packages for upgrading programs in the tire pressure monitoring sensor) is written through the terminal, and the programming information is uploaded to the server by the terminal. The third request information is triggered by a user on the terminal through a functional key indicating uploading the updating information.

When the new vehicle information appears (for example, a new vehicle model appears), the new vehicle information may be added to the server. That is, developers may upgrade a database of the vehicle information stored in the server, and add or upgrade the vehicle models or data according to market dynamics, so that users may have more choices through the APP.

Specifically, the developers may directly issue fourth request information for adding new vehicle information through the interactive interface of the server, or through the equipment networking with the server. When receiving the fourth request information, the server stores the new vehicle information and the corresponding new updating information. When the user needs to configure or program the pressure monitoring sensor in the new vehicle, the user may access the new updating information through the terminal since the new vehicle information and the corresponding new updating information have been added to the server, so as to configure or program the tire pressure monitoring sensor in the new vehicle.

This embodiment provides a near-field communication-based tire pressure monitoring system, where the operation of uploading the updating information to the server is enabled through the terminal.

Further, the data stored in the server includes TPMS sensor (tire pressure monitoring sensor) transmission protocol, transmission frequency, radio frequency modulation, TPMS sensors pressure data, temperature data, battery level data, speed monitoring data, etc.

Further, the tire pressure monitoring sensor in the near-field communication-based tire pressure monitoring system also supports data transmission through LF and RF.

Specifically, in this embodiment, the RF used by the tire pressure monitoring sensor supporting the near-field communication is in the range of 315 MHz to 433 MHz; the carrier modulation mode of frequency shift key (FSK), amplitude shift key (ASK) or binary off-on key (OOK) is adopted. The communication is with different RF data encodings, and the main data transmission rates are 4.8 K bits, 9.6 K bits and 19.2 K bits.

The LF communication used in the tire pressure monitoring sensor supporting the near-field communication usually adopts 125 KHz carrier, modulation and non-modulation, and the baud rate of data transmission usually adopts 9600 bits.

The NFC used by the tire pressure monitoring sensor supporting the near-field communication in this embodiment is mainly operated at the public frequency band of 13.56 MHz, with the ISO/IEC 18000-3 wireless transmission standard, and the data transmission rate is between 106K bits to 424K bits. Therefore, the data transmission rate is 10 to 42 times higher compared with the LF data transmission rate of 9600 bits, greatly improving the communication speed.

Specifically, the near-field communication-based tire pressure monitoring system provided by this embodiment is a system capable of providing human-computer interaction mechanism between TPMS sensor and users.

A method for updating information of the tire pressure monitoring sensor through the near-field communication system provided in this embodiment includes: downloading, by a user, TPMS sensor data of the corresponding model from a mobile phone APP or through the cloud; and based on NFC technology, configuring or programming the obtained sensor data into the TPMS sensor to achieve rapid and reliable product upgrading. In addition, based on NFC communication, reading the corresponding information inside the sensor through mobile phone APP, such as querying the information of the sensor program corresponding to the current vehicle model, ambient temperature, power supply voltage, software and hardware versions, etc.

In a second aspect, the present disclosure provides a tire pressure monitoring sensor, including a processor and an antenna for near-field communication; where after the tire pressure monitoring sensor establish a connection of the near-field communication with a terminal, the antenna receives updating information sent by the terminal, and the processor processes the updating information;
where, the updating information includes configuration information for configuring the tire pressure monitoring sensor or programming information for programming the tire pressure monitoring sensor.

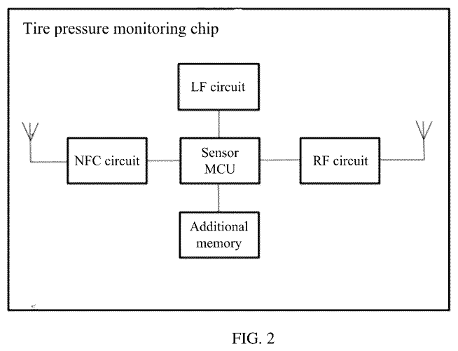

FIG. 2 is a circuit block diagram of a tire pressure monitoring sensor in accordance with an embodiment of the present disclosure. Referring to FIG. 2, the tire pressure monitoring sensor includes a sensor microprogrammed control unit (MCU), an NFC circuit, an LF circuit, an RF circuit and additional memories. Further, near field data transmission is realized by the NFC circuit and wireless data transmission is realized by the LF circuit and the RF circuit. Specific way of data transmission may be determined according to hardware structure of the terminal. For example, if a terminal supports NFC function, the transmission of updating data is realized through NFC.

This embodiment provides a tire pressure monitoring sensor. By setting the processor and the antenna for near-field communication, the tire pressure monitoring sensor supports the near-field transmission and avoids interference in data transmission with the terminal.

Further, based on the embodiments above, the antenna is fixed on a sealing upper cover or a sealing lower cover of the tire pressure monitoring sensor; and
the antenna and a main printed circuit board in the processor are conducted by a metal wire through welding, or the antenna and the main printed circuit board in the processor are conducted by a metal contact pin.

This embodiment provides a tire pressure monitoring sensor. Without changing the overall layout of the tire pressure monitoring sensor, the tire pressure monitoring sensor is modified in terms of enabling the NFC function.

In a third aspect, the present disclosure provides a tire, including a tire pressure monitoring sensor described above, and
the tire pressure monitoring sensor is locked on a valve mouth of the tire or attached to a rubber inner surface of the tire.

In a fourth aspect, the present disclosure provides a vehicle including the tire described above.

This embodiment provides a tire and a vehicle, both of which includes the tire pressure monitoring sensor described above. Through the near-field communication, data transmission may be realized without signal interference, ensuring the reliability and security of data transmission.

This embodiment provides a near-field communication-based tire pressure monitoring system, a sensor, a tire and a vehicle, which have the following advantages: (1) by using the near-field communication (NFC) communication mechanism and one-to-one transmission, the inherent wireless interference defects of LF or RF is solved, the crosstalk between products is avoided, thereby improving the stability of product transmission; (2) the transmission rate of NFC is 10 to 42 times of the current LF transmission rate, thus the speed is faster when using mobile APP configuration or programming; (3) mobile phone APP may be downloaded online anytime and anywhere, and users may use the APP conveniently; and (4) cloud storage management of corresponding service vehicle model data makes the background update more convenient.

Finally, it should be noted that the above embodiments are only used to illustrate the technical solutions of the present disclosure, rather than limiting it. Although the present disclosure is described in detail with reference to the above embodiments, those of ordinary skill in the art should understand that they may still modify the technical solutions recorded in the above embodiments, or make equivalent replacements for some or all of the technical features. And these modifications or replacements do not detach the essence of the corresponding technical solutions from the scope of the technical solutions of various embodiments of the present disclosure.

1. A near-field communication-based tire pressure monitoring system, comprising a server, a terminal supporting near-field communication and a tire pressure monitoring sensor supporting the near-field communication; wherein
the terminal is configured to, after receiving a first request information for updating the tire pressure monitoring sensor, obtain vehicle information of a vehicle where the tire pressure monitoring sensor is located and send the vehicle information to the server;
the server is configured to, after receiving the vehicle information, query updating information corresponding to the vehicle information and send the updating information to the terminal; and
the terminal is further configured to receive the updating information, and after detecting a connection establishing the near-field communication with the tire pressure monitoring sensor, send the updating information to the tire pressure monitoring sensor;
wherein, the updating information comprises configuration information for configuring the tire pressure monitoring sensor or programming information for programming the tire pressure monitoring sensor; and the vehicle information comprises vehicle brand, vehicle model, vehicle manufactory year and version number of program in the vehicle.

2. The system according to claim 1, wherein
the terminal is further configured to, after detecting the connection establishing the near-field communication with the tire pressure monitoring sensor, and when receiving a second request information for obtaining tire pressure monitoring data for monitoring a tire, send the second request information to the tire pressure monitoring sensor; and
the tire pressure monitoring sensor is configured to, after receiving the second request information, send stored tire pressure monitoring data to the terminal through the connection establishing the near-field communication, for the terminal to display received tire pressure monitoring data.

3. The system according to claim 2, wherein
the terminal is further configured to sends the received tire pressure monitoring data to the server, for the server to store the received tire pressure monitoring data.

4. The system according to claim 1, wherein, the terminal is a smart phone or a handheld tablet;
wherein, the terminal is further configured to, after receiving the vehicle information selected by a user through an application installed on the terminal, send the vehicle information to the server to obtain the updating information corresponding to the vehicle information from the server, and after establishing the connection of the near-field communication with the tire pressure monitoring sensor, send the obtained updating information to the tire pressure monitoring sensor.

5. The system according to claim 1, wherein
the terminal is further configured to, after receiving a third request information for uploading the updating information of the vehicle to the server, obtain the updating information and the vehicle information corresponding to the updating information, and send the updating information and the vehicle information corresponding to the updating information to the server;
the server is further configured to store the received updating information and vehicle information corresponding to the updating information; and
the server is further configured to, when receiving a fourth request information for adding new vehicle information, store the new vehicle information, and after receiving new updating information corresponding to the new vehicle information, store the new updating information and the new vehicle information corresponding to the new updating information.

6. A tire pressure monitoring sensor, comprising a processor and an antenna for near-field communication, wherein
after the tire pressure monitoring sensor establish a connection of the near-field communication with a terminal, the antenna receives updating information sent by the terminal, and the processor processes the updating information;
wherein, the updating information comprises configuration information for configuring the tire pressure monitoring sensor or programming information for programming the tire pressure monitoring sensor.

7. The sensor according to claim 6, wherein, the antenna is fixed on a sealing upper cover or a sealing lower cover of the tire pressure monitoring sensor; and
the antenna and a main printed circuit board in the processor are conducted by a metal wire through welding, or the antenna and the main printed circuit board in the processor are conducted by a metal contact pin.

8. A tire, comprising the tire pressure monitoring sensor according to claim 6; wherein
the tire pressure monitoring sensor is locked on a valve mouth of the tire or attached to a rubber inner surface of the tire.

9. A vehicle, comprising the tire according to claim 8.

10. A tire, comprising the tire pressure monitoring sensor according to claim 7; wherein
the tire pressure monitoring sensor is locked on a valve mouth of the tire or attached to a rubber inner surface of the tire.

11. A vehicle, comprising the tire according to claim 10.
